(19) United States
(12) Patent Application Publication
(10) Pub. No.: US 2006/0238468 A1
(43) Pub. Date: Oct. 26, 2006

(54) Light emitting device and display device

(75) Inventor: Takuro Ishikura, Kashihara-Shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/361,162

(22) Filed: Feb. 24, 2006

(30) Foreign Application Priority Data
Apr. 22, 2005 (JP) 125744/2005

(51) Int. Cl. G09G 3/32

(52) U.S. Cl. 345/83

(57) ABSTRACT

A light emitting device of the present invention includes: a plurality of light emitting sections arranged in a matrix of n×m (n and m are positive integral numbers); power source lines for supplying power currents for light emission to the respective light emitting sections; control sections for controlling supply of the power currents to the respective light emitting sections; drive control sections for controlling by connecting or disconnecting respective control signals to the control sections; and holding sections for holding the control signals each indicative of supply of the power current to each of the light emitting sections. With this structure, a flat type light emitting device and a display device can be provided which realize (i) uniform light emission by easily adjusting hue and brightness of light emission in a flat panel including the light emitting sections and (ii) reduction in power consumption.

This Nonprovisional application claims priority under 35 U.S.C. § 119(a) on Patent Application No. 125744/2005 filed in Japan on Apr. 22, 2005, the entire contents of which are hereby incorporated by reference.

### FIELD OF THE INVENTION

The present invention relates to a flat type light emitting device and a display device having the same both of which include a large number of self-light-emitting elements, such as light emitting diodes (hereinafter referred to as LEDs), and realizes uniform light emission of the self-lightemitting elements easily as well as reduction in power consumption.

### BACKGROUND OF THE INVENTION

Conventionally, LEDs have had the following advantages compared to light bulbs. First, LEDs have excellent color purity and visibility, requiring no colored lens and avoiding washout in sunlight such as late afternoon sunlight. Further, power consumption of LEDs is less than one third of that of light bulbs. Since LEDs have a long life time, the frequencies and costs for maintenance are reduced. In addition, since the LEDs are used in large numbers in one device, it has become possible to eliminate the fear that all the LEDs might go out. With the above advantages, LEDs have been widely used in outdoor settings for flat type light emitting devices and display devices (e.g. see “Attractions of blue color light emitting devices” edited by Akasaki Isamu, Japan Industrial Standard Committee, published on May 1, 1997).

In recent years, with the remarkable development of high luminance InGaN-related blue color LEDs, it has become possible to efficiently reproduce white light based on a principle of additive mixture of colors. This leads to the development of three-in-one chip type LEDs in which three LEDs having three primary colors, i.e., InGaN-related blue, InGaN-related green, and a InGaAlP-related red, are packaged on one chip. Each of the three-in-one chip type LEDs is in a small shape of 3(W)×3(L)×1(H). Further, unlike a shell-type lamp, the three-in-one chip type LEDs do not converge light with a mold lens and has a wide half-value angle of ±65°. The blue color LED, green color LED, and red color LED have intensities of 50 mcd, 150 mcd, and 30 mcd, respectively, with a forward current of 20 mA. Thus, the three-in-one chip type LEDs achieve sufficient brightness for practical use, considering their small size. With the use of such three-in-one chip type LEDs, flat type light emitting devices and display devices with colors have been developed. Two systems have been known for driving the light emitting device and display device, i.e., a static drive system and a dynamic drive system. Recently, the dynamic drive system has been often used due to demands for reduction in size, weight, and cost.

In the dynamic drive system, m scan lines and n data lines are mutually intersected in a matrix manner, and LEDs are disposed at respective intersections (n, m are positive integrals). The LED at the intersection of the scan line and the data line both being ON emits light. That is, the scan lines are scanned one by one so that LEDs for each scan line emit light or carries out display.

However, in the conventional dynamic drive system, since the scan lines are scanned one by one, each of the LEDs emits light for 1/n or 1/m of a drive time at the longest. Therefore, in order to maintain the brightness, a drive current needs to be n or m times greater than a drive current under the direct current driving conditions. As illustrated in FIG. 3, an increased drive current causes increase in loss of power consumption in the LED due to the heat generated by its internal resistance. In this way, the dynamic drive system has suffered from increase in power consumption.

### SUMMARY OF THE INVENTION

An object of the present invention is to provide a light emitting device and a display device which maintain light intensity with a reduced drive current, and control the drive currents to the respective LEDs so as to easily realize overall uniformity in hue and brightness.

To attain the foregoing object, a light emitting device of the present invention includes: a plurality of light emitting sections arranged in a matrix manner; power source lines for supplying power currents for light emission to the respective light emitting sections; control sections for controlling supply of the power currents to the respective light emitting sections; drive control sections for controlling respective control signals to the control sections by connecting or disconnecting the control signals; and holding sections for holding the control signals each indicative of supply of the power current to each of the light emitting sections.

According to the arrangement, the drive control sections control the control sections by connecting or disconnecting the control signals each indicative of supply of the power current to each of the light emitting sections. This allows for control of supply of the power currents to the respective light emitting sections, enabling control of light emitting states of the light emitting sections for their on/off lights.

Further, in the above arrangement, the drive control section controls the control section with a pulse signal indicating information of a current or a voltage, i.e., externally supplied drive data. As a result, the light emitting sections are driven under dynamic drive conditions. In this arrangement, since the holding section for holding the control signal is provided, a light emitting state of each of the light emitting sections is maintained even in a period during which a pulse signal indicating no supply of power current to the light emitting section is supplied, after the period during which the power current is supplied to the light emitting section according to the control signal based on the pulse signal.

As described above, with an externally supplied drive data, the light emitting sections are individually driven in a static manner. Thus, it is possible to control hue and brightness by changing the externally supplied drive data, and to maintain a light emitting state of the light emitting section. This allows for (i) driving at a low current which causes less loss of internal resistance and (ii) reduction in power consumption. As the externally supplied drive data, such data is used that has been previously stored in a memory element or the like. Further, the above arrangement allows for reduction in power consumption with regard to driving operation because the signal to the drive control section can be supplied in the form of a pulse.

That is, according to the above arrangement, power consumption is reduced with regard to driving operation. Further, more uniform brightness and more uniform hue (e.g. white) are easily realized in light emission in a flat panel including multiple light emitting sections by controlling each of the light emitting sections.

According to the present invention, to attain the foregoing object, a display device includes the light emitting device of the present invention. According to the arrangement, such a display device is realized that maintains, by employing the light emitting device of the present invention, light intensity at a certain level with a reduced drive current. Further, the display device enables easy adjustment for more uniform hue and brightness by controlling the drive current to each of the LEDs.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating a substantial circuit of a light emitting device of the present invention.

FIG. 2 is a block diagram illustrating a display device of the present invention.

FIG. 3 is a graph showing a relationship between a forward voltage and a forward current, which are applied to a light emitting diode.

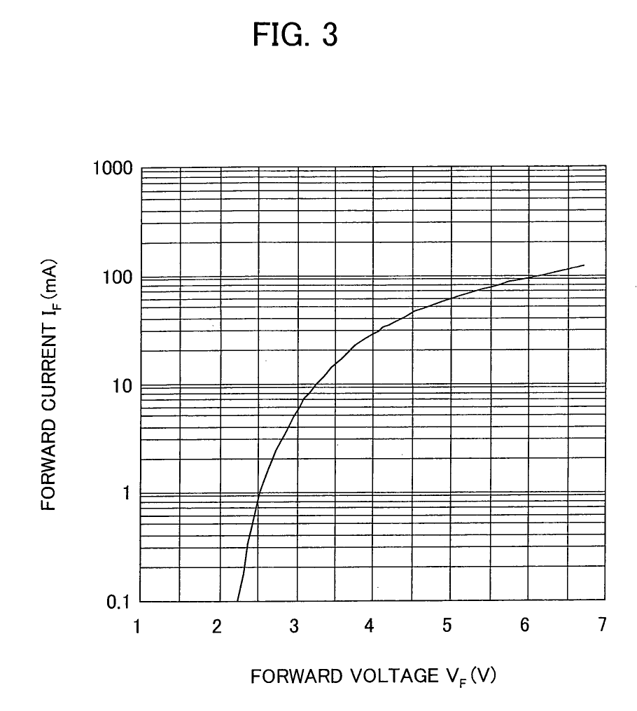

### DESCRIPTION OF THE EMBODIMENTS

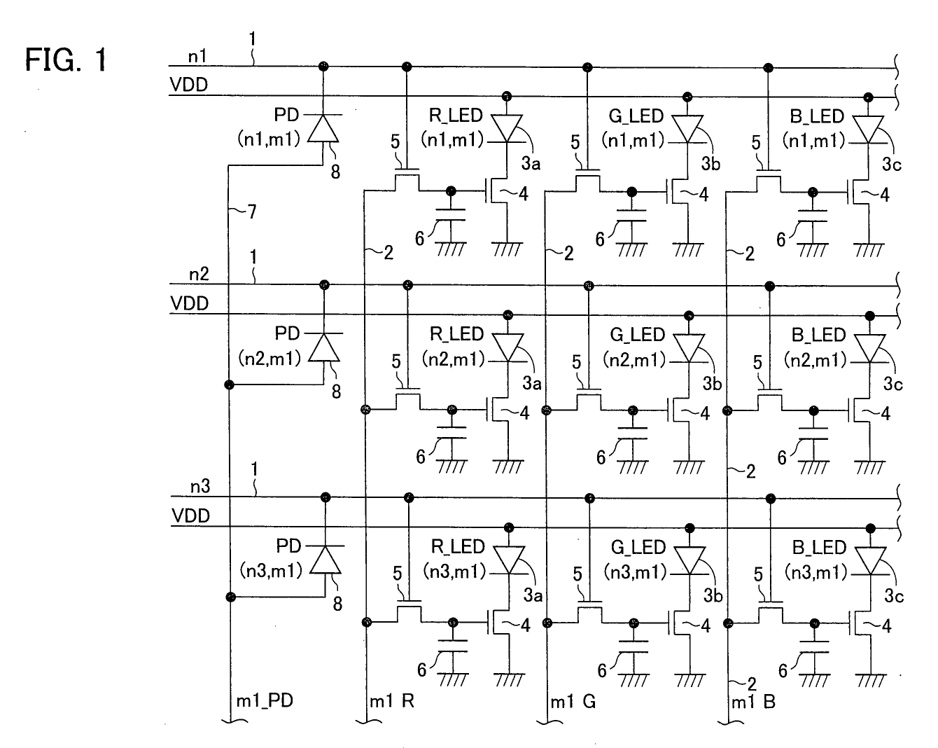

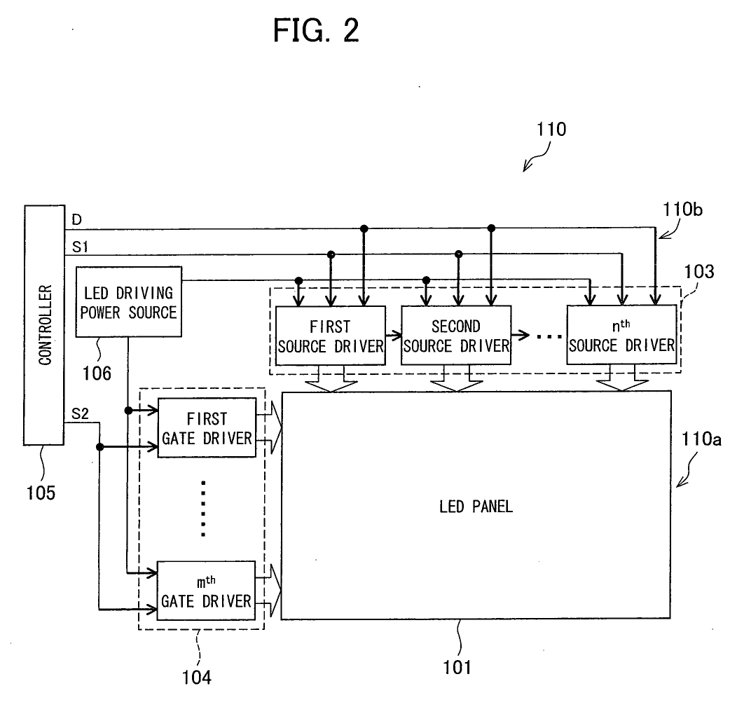

With reference to FIGS. 1 and 2, the following describes embodiments of a flat type light emitting device, in accordance with the present invention and a display device using the flat type light emitting device.

### First Embodiment

As illustrated in FIG. 1, in a light emitting device of the present embodiment, n scan lines 1 arranged substantially in parallel and m data lines 2 arranged substantially in parallel are provided on a substrate (not shown). The scan lines 1 and the data lines 2 are mutually intersected so that their intersections constitute a matrix of n×m. The n and m are positive integral numbers, and may be different or the same numbers. Further, power lines VDD are disposed along the scan lines 1. The power lines VDD supply power current to light emitting diodes 3a, 3b, and 3c. The light emitting diodes (hereinafter referred to as LEDs) will be explained later.

At the intersections, the red color LED 3a, the green color LED 3b, and the blue color LED 3c are alternately provided in this order in lines along the scan lines 1. Anodes of the LEDs 3a, 3b, and 3c are connected to each of the corresponding power line VDD. The red color LED 3a is made of an InGaAlP or a similar material, or GaAlAs or a similar material. The green color LED 3b is made of a GaP or a similar material, or InGaN or a similar material. The blue color LED 3c is made of an SiC or a similar material, or InGaN or a similar material.

Further, cathodes of the LEDs 3a, 3b, and 3c are connected to first transistors 4, respectively. Each of the first transistors 4 serves as a control section (drive section) for adjusting and controlling a power current so that a target power current is supplied to each of the LEDs 3a, 3b, and 3c. Another terminal of the first transistor 4 is connected to ground. As the first transistor 4, generally, a bipolar transistor or a field effect transistor (FET) is used.

Further, a second transistor 5 is connected to a control terminal of each of the first transistors 4. The second transistor 5 serves as a drive control section for driving and controlling the first transistor 4 so that the first transistor 4 is connected or disconnected. Specifically, each control terminal (second control terminal) of the second transistor 5 is connected to a corresponding scan line 1. As to the other two terminals of the second transistor 5, one is connected to a control terminal of a corresponding first transistor 4 and the other is connected to a corresponding data line 2. With the arrangement, a power current is adjusted and controlled so that a target current is supplied via a corresponding first transistor 4. The controlling of such a current includes an ON/OFF controlling of the power current. This enables a second transistor 5 to supply a control signal from a corresponding data line 2 into a control terminal of a corresponding first transistor 4 (first control terminal, i.e. a base terminal in case of bipolar transistors, or a gate terminal in case of FETs). The second transistor 5 may be any element having a switching function. Generally, a bipolar transistor or a field effect transistor (FET) is used as the second transistor 5.

Each of the first transistors 4 is driven and controlled (connected or disconnected) by connecting or disconnecting the power current according to whether or not an applied voltage or an applied current to the first control terminals of the first transistor 4 exceeds a threshold value.

Specifically, when a scan line 1 becomes in a state allowing a corresponding second transistor 5 to turn on (e.g. high level), a control signal from a corresponding data line 2 is applied to a control terminal of the first transistor 4 via the second transistors 5. Each of the control signals indicates a current or a voltage which affects a drive state of each of the first transistors 4. Thus, the LEDs 3a, 3b, and 3c can be controlled to emit light having a desirable brightness (optical power). On the other hand, in a case where the amount of emitted light is controlled by an OFF pulse, a control signal should be adjusted to turn off a first transistor as follows, in order for the LEDs 3a, 3b, and 3c not to emit light. That is, when a scan line 1 is in a state allowing a corresponding second transistor 5 to turn on (e.g. high level), a corresponding data line 2 is grounded so that a control signal becomes a low level.

In the present embodiment, a capacitive element, i.e. a capacitor 6 serving as a holding section, is provided between a control terminal of a corresponding first transistor 4 and ground. The capacitor 6 stores an electric charge even when a pulse signal of the scan line 1 changes from an ON state (e.g. a high level) allowing the second transistor 5 to turn on into an OFF state (e.g. a low level) allowing the second transistor 5 to turn off. This is because the capacitor 6 is charged with the electric charge of the control signal of the data line 2 during which the signal from the scan line 1 is at a high level. This allows the first transistor 4 which the control signal has turned on to keep turning on until the electric charge of the capacitor 6 decreases in quantity of less than a certain level.

This allows the first transistors 4 to keep turning on while controlling supplying a power current from the power lines VDD to the LEDs 3a, 3b, and 3c which are connected to the first transistors 4. As a result, light emission of the LEDs 3a, 3b, and 3c is maintained.

According to the embodiment, the capacitors 6 serving as holding circuits are added to the respective first transistors 4 serving as respective LED drivers. in a flat type light emitting device including LEDs 3a, 3b, and 3c which constitute a matrix of n×m. With the arrangement, a driving condition (a voltage or a current) for each of the scan lines 1 is inputted in the form of a pulse signal. This enables the LEDs to emit light (illuminate) with a desirable condition, and to keep the light emission even when the pulse signal changes into an OFF state.

According to the present embodiment, it is possible to provide a flat type light emitting device, with LEDs 3a, 3b, and 3c constituting a matrix of n×m, which can carry out multi-color light emission and can display an image. It is also possible to reduce the number of wire by driving the LEDs 3a, 3b, and 3c dynamically.

In addition, the capacitors 6 having a sample hold function are added to the respective first transistors 4, which serve as drivers for supplying power current to the LEDs 3a, 3b, and 3c so as to drive them. This allows a state where the latest inputted signals are maintained (ON state) even when no signal is inputted (OFF state). Therefore, even when signals determining a drive state are inputted dynamically, illuminations of the LEDs are maintained almost all the time. This reduces power consumption of the driving operation, while controlling light emission of the LEDs 3a, 3b, and 3c, individually. Further, uniform brightness and hue are realized.

Further, the light emitting device can maintain a state, realized by inputting a drive signal, even when no drive signal is actually inputted to a scan line 1. This allows control of the amount of emitted light by varying a ratio between ON and OFF drive states for each of the LEDs. In a case where a signal inputted to a scan line 1 is an ON/OFF signal, the number of ON signals or the number of OFF signals is set for each of the LEDs 3a, 3b, and 3c to realize uniform light emission of the LEDs 3a, 3b, and 3c.

### Second Embodiment

As illustrated in FIG. 1, in addition to the arrangement described in the first embodiment, a second embodiment includes a photodiode (photodetecting section) 8 provided for each set of adjacent LEDs 3a, 3b, and 3c. The photodiode 8 measures a brightness of at least one of the LEDs 3a, 3b, and 3c, and has a cathode connected to a corresponding scan line 1 and an anode connected to a corresponding photodetecting line 7. The photodetecting line 7 is disposed in parallel to the data lines 2. If a scan line 1 has a high level and at least one of the LEDs 3a, 3b, and 3c connected to a corresponding scan line 1 emits light, then it is possible to detect a brightness of the light thus emitted.

With the arrangement, in the second embodiment, since the photodiodes 8 are further provided, it is possible to detect a variation in brightness if the light emission of the LEDs varies due to e.g. degradation of the brightness or the like. This is because a comparison between a current output of light emission of and a previous output of light emission of LEDs can be made by causing red-, green-, and blue-color LEDs 3a, 3b and 3c to independently emit light so that a corresponding photodiode 8 detects the outputs of the light emitted. Based on a variation in brightness thus detected, the LEDs 3a, 3b, and 3c are individually controlled. Thus, overall uniformity in brightness and hue is easily attained in a flat type light emitting device.

### Third Embodiment

With reference to FIG. 2, the following describes a display device using a light emitting device of the present invention as a third embodiment of the present invention. As illustrated in FIG. 2, an active matrix type display device 110 includes an LED display section 110a and a drive circuit 110b for driving the LED display section 110a.

The LED display section 110a includes pixels, i.e., the LEDs 3a, 3b, and 3c, arranged in a matrix (grid) of 1024×768 dots, for example. Based on image data, the LED display section 110a sequentially or intermittently carries out displaying with respect to each horizontal scan line, in a vertical direction. This allows an image to be displayed. In the case using a matrix of 1024×768 dots, a single horizontal scan line has 1024 dots. The number of pixels to be used may be 1280×1024, 1600×1200, or 3200×2400, as appropriate.

The drive circuit 110b includes thereon a source driver 103, a gate driver 104, a controller (control circuit, drive circuit) 105, and an LED driving power source 106. The source driver 103 and the gate driver 104 are realized by an integrated circuit (IC).

In the above structure, the source driver 103 receives externally supplied image data for display via the controller 105 as display data D (digital signal). In the source driver 103, the display data D thus received is subjected to a time-division processing, and is latched by the first source driver through the nth source driver of the source driver 103, and then is subjected to a D/A conversion in synchronization with a horizontal synchronization signal supplied from the controller 105.

Via a D/A conversion of the display data D which has been thus subjected to a time-division, analog display data signals are prepared. The analog display data signal indicates an analog voltage for gradation display (hereinafter referred to as “gradation display voltage”). The analog display data signals are supplied via data lines 2 (not shown) to corresponding LEDs 3a, 3b, and 3c in an LED panel 101 of the LED display section 110a.

Further, the controller 105 outputs, to the first source driver through the nth source driver of the source drivers 103, (i) image data signals R, G, and B, (ii) horizontal synchronization signals (i.e., start pulse signal SP and latch signal Ls), and (iii) a clock signal clk. The controller 105 also outputs to the gate drivers 104 a vertical synchronization signal and the horizontal synchronization signals. Further, the controller 105 includes an I/O circuit, display RAMs for storing the image data, generation circuits or output circuits for various control signals, and the like.

In such a display device, for example, the capacity of a capacitor 6 may be set so that a first transistor 4 keeps turning on during a period of a single horizontal synchronization signal. Further, by controlling a current or a voltage to be applied to each of the data lines 2 so that a first transistor 4 is controlled which receives such a current or such a voltage as a control signal from the data lines 2, it is possible to control a current flowing each of the LEDs. This allows a gradation expression, thereby enabling to realize multiple colors.

The above embodiments exemplify a structure in which an LED is used as a light emitting section. However, any element, which is self-illuminated in response to an applied voltage or current, can be used as the light emitting section of the present invention. For example, an electroluminecsent light emitting element can serve as the light emitting section.

Further, the above embodiments deal with cases where a capacitor is used as the holding section. However, in the present embodiment, the holding section is not limited to the capacitor, provided that it has a capacitive property. For example, a liquid crystal cell may be used as a capacitive element. In this case, the liquid crystal cell may serve as an optical shutter for a corresponding LED.

A conventional matrix display device having reduced connections between components is disclosed in the Japanese Unexamined Patent Publication, No. 322296/1992 (Tokukaihei 4-322296, publication date: Nov. 12, 1992) (corresponding U.S. Pat. No. 5,237,314 (publication date: Aug. 17, 1993). This publication discloses that the connections between components are reduced by using light emitting means and light sensing means. However, as to a function of holding display, there is no disclosure or suggestion in this publication.

The Japanese Unexamined Patent Publication, No. 536337/2004 (Tokuhyo 2004-536337, publication date: Dec. 2, 2004) (corresponding International Patent Application, Publication No. 03/007286 (international publication date: Jan. 23, 2003) discloses that a display element drive circuit is disposed between (i) a node, i.e. data storage node for storing a video signal and (ii) a display element, and that the data storage node is correlated with a data storage capacitor. With this arrangement, when a screen image is not changed by video signals, the screen image is stored. It is possible to suspend an addressing of the video signals to the screen. A pixel architecture of this type can be used for a liquid crystal display. Specifically, such a pixel architecture is most suitably used in a situation where a display element cannot be used for storing an electric charge indicative of video information. Examples of such a display are an active matrix polymer LED or organic LED (OLED) display devices which use light emitting diodes. With the above pixel arrangement, it is possible to take an input to a temporary storage circuit of a refresh circuit from an output of a display element drive circuit. This will bring an advantage during buffering a signal acquired from the data storage node (Japanese PCT National Phase Unexamined Patent Publication No. 536337/2004 (Tokuhyo 2004-536337), FIG. 5, Paragraph 0037).

However, the above publication does not teach or suggest such an arrangement as disclosed in the present invention that a power current to be supplied to a corresponding one of the LEDs (light emitting sections) 3a, 3b, and 3c is held even when a drive signal of a corresponding scan line 1 is changed into a low level.

As described above, light emitting device and display device of the present invention are capable of emitting light and carrying out display while reducing power consumption. Thus, the light emitting device and the display device are preferably applied to various fields requiring light emission, such as (i) color displays for indoor use, (ii) displays for outdoor use in advertisements, publications, sports stadiums, (ii) displays for use in equipments for transportations, and (iii) equipments for entertainments. Further, the present invention is used in a liquid crystal backlight or the like, so as to serve as a flat type light emitting device which requires uniform hue and brightness.

As described above, the light emitting device includes: a plurality of light emitting sections arranged in a matrix manner; power source lines for supplying power currents for light emission to the respective light emitting sections; control sections for controlling supply of the power currents to the respective light emitting sections; drive control sections for controlling respective control signals to the control sections by connecting or disconnecting the control signals; and holding sections for holding the control signals each indicative of supply of the power current to each of the light emitting sections.

According to the arrangement, thanks to the holding sections, a target light emitting state in each of the light emitting sections is maintained according to drive information in an externally inputted pulse signal. This allows the light emitting state of the light emitting section to be maintained with its light intensity even in a period during which the pulse signal is not supplied (OFF period). Since the light emitting sections are individually controlled with the external signals, the light emitting sections can easily adjust their hues and brightnesses of light rays emitted therefrom, so that more uniformity in hue and brightness is realized. Further, loss of power consumption, which has been a problem, is suppressed, and power saving is therefore realized.

In the light emitting device, the control sections may be first transistors, and each of the control sections may be connected or disconnected the power current according to whether or not an applied voltage or current to each of first control terminals of the first transistors exceeds a threshold value.

The light emitting device may include: a plurality of scan lines; and a plurality of data lines, the scan lines and data lines controlling light emission of the light emitting sections and being mutually intersected in a matrix manner, the drive control sections being second transistors provided to the respective light emitting sections, the scan lines being connected to respective second control terminals of the second transistors, the data lines being connected to the respective second transistors so as to supply the control signals to the first control terminals of the first transistors.

According to the arrangement, a plurality of scan lines and a plurality of data lines are mutually intersected in a matrix manner. With this arrangement, the light emitting sections are driven under dynamic drive conditions. Further, the number of wires is reduced, so that size reduction is realized.

In the light emitting device, the light emitting sections may be light emitting diodes. Further, the control sections may be respectively connected in series to cathodes of the light emitting diodes.

In the light emitting device, the holding sections may be capacitive elements. Further, the capacitive elements may be capacitors.

The light emitting device may include the light detecting sections for detecting brightness of light emitted from the light emitting sections, for example, photodiodes. According to the arrangement, even if the light emission of the light emitting sections varies due to e.g. degradation of the brightness, the photodetecting sections detect a variation in brightness of the light emitted from the light emitting sections. As a result, brightness and hue can be easily controlled for their uniformity with regard to the light emitted from the light emitting sections.

The display device includes the light emitting device. According to the above arrangement, employing any of the aforesaid light emitting devices, the display device realizes excellence in uniformity of brightness and hue and reduction in power consumption.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A light emitting device comprising:
a plurality of light emitting sections arranged in a matrix manner;
power source lines for supplying power currents for light emission to the respective light emitting sections;
control sections for controlling supply of the power currents to the respective light emitting sections;
drive control sections for controlling respective control signals to the control sections by connecting or disconnecting the control signals; and
holding sections for holding the control signals each indicative of supply of the power current to each of the light emitting sections.

2. The light emitting device according to claim 1, wherein the control sections are first transistors, and each of the control sections is connected or disconnected the power current according to whether or not an applied voltage or current to each of first control terminals of the first transistors exceeds a threshold value.

3. The light emitting device according to claim 2, further comprising:
a plurality of scan lines; and
a plurality of data lines,
the scan lines and data lines controlling light emission of the light emitting sections and being mutually intersected in a matrix manner,
the drive control sections being second transistors provided to the respective light emitting sections,
the scan lines being connected to respective second control terminals of the second transistors,
the data lines being connected to the respective second transistors so as to supply the control signals to the first control terminals of the first transistors.

4. The light emitting device according to claim 1, wherein the light emitting sections are light emitting diodes.

5. The light emitting device according to claim 4, wherein the control sections are respectively connected in series to cathodes of the light emitting diodes.

6. The light emitting device according to claim 1, wherein the holding sections are capacitive elements.

7. The light emitting device according to claim 6, wherein the capacitive elements are capacitors.

8. The light emitting device according to claim 1, further comprising light detecting sections for detecting brightness of light emitted from the light emitting sections.

9. A display device including a light emitting device comprising:
a plurality of light emitting sections arranged in a matrix manner;
power source lines for supplying power currents for light emission to the respective light emitting sections;
control sections for controlling supply of the power currents to the respective light emitting sections;
drive control sections for controlling respective control signals to the control sections by connecting or disconnecting the control signals; and
holding sections for holding the control signals each indicative of supply of the power current to each of the light emitting sections.
